(19) United States
(12) Patent Application Publication
(10) Pub. No.: US 2022/0061241 A1
(43) Pub. Date: Mar. 3, 2022

(54) HARVESTING AIR TOOL AND AIR CIRCULATOR FOR AEROPONIC OR HYDROPONIC FARMING SYSTEMS

(71) Applicant: Local Urban Vegetables, lnc., Commerce, CA (US)

(72) Inventors: Morris Gasmer, Whittier, CA (US); Kristopher Russell, Whittier, CA (US)

(73) Assignee: Local Urban Vegetables, lnc., Commerce, CA (US)

(21) Appl. No.: 17/416,701

(22) PCT Filed: Dec. 19, 2019
(86) PCT No.: PCT/US2019/067662

§ 371 Date: Jun. 21, 2021

Related U.S. Application Data
(60) Provisional application No. 62/782,888, filed on Dec. 20, 2018.

(51) Int. Cl. A01G 31/06

(52) U.S. Cl. CPC A01G 31/06

(57) ABSTRACT

A bracket for holding a plurality of plant receptacles for use in an automated systems in an aqueous farming system that provides an under-canopy circulation system.

### FIELD OF THE INVENTION

The present invention relates generally to aqueous farming systems, and more particularly to an under-canopy air circulation system for an aqueous farming system.

### BACKGROUND

In aqueous farming, a plant may be placed in an opening of a barrier. A root system of the plant is in an aqueous environment on one side of the barrier, and a canopy including the stem and leaves of the plant is exposed to an atmospheric environment on an opposing side of the barrier. The aqueous environment may be a liquid environment, as is the case for hydroponically grown crops, or a fog or mist environment, as is the case for aeroponically grown crops. The barrier may be a floor or other construct, for example a mesh, or in some cases a wall or wall-like structure.

For many plants of interest, for example leafy crops, exposure of plant leaf and canopies to the mist environment may be deleterious to plant growth and health. A barrier may be used to separate the mist environment for the roots from the rest of the plant. Such a barrier also may be beneficial in reducing a volume in which the mist environment is to be provided. Segregating the leaves and canopy of the plant from the mist environment, however, may be insufficient to provide an environment suitable for the leaves and canopy to thrive.

### BRIEF SUMMARY OF THE INVENTION

A holder for holding plants in an aqueous farming system may be used to provide under canopy air circulation for the plants in accordance with invention. In various embodiments the holder includes air ejection holes for expelling air into an under-canopy region of the plants held by the holder. In some embodiments, the holder may include air intake holes into an interior cavity of the holder, with one or more fans mounted to the holder for forcing air through the air intake holes and the interior cavity. In some embodiments the holder includes plant holding holes, extending through the holder, for holding the plants. In some embodiments the holder may be a bracket. In some embodiments the bracket includes a base with the interior cavity and pairs of arms extending from the base.

Some embodiments provide a bracket having a base including an interior volume, with first apertures extending through the base for receiving plants and second apertures extending into the interior volume. Some such embodiments include a third aperture for providing air flow into the interior volume. Some such embodiments include a first fan positioned to provide the air flow through the third aperture into the interior volume. Some such embodiments may include a fourth aperture for providing air flow into the interior volume, and a second fan positioned to provide the air flow through the fourth aperture into the interior volume. In some such embodiments, the first apertures have a diameter at least ten times greater than the second apertures. In some embodiments the second apertures are uniformly arranged around the first apertures.

These and other embodiments in accordance with aspects of the invention are more fully comprehended on review of this disclosure.

### BRIEF DESCRIPTION OF THE FIGURES

FIG. 1 is an isometric view of a portion of a grow wall in accordance with an embodiment of the invention.

FIG. 2 is an isometric top view of a bracket that provides an under-canopy air circulation system in accordance with some embodiments of the invention.

FIG. 3 is an exploded view of a portion of the bracket of FIG. 2 that provides an under-canopy circulation.

FIG. 4 is a partial top view of end portions of a further bracket that provides an under-canopy air circulation system in accordance with aspects of the invention.

FIG. 5 is a cross sectional view of the bracket that provides an under-canopy air circulation of FIG. 4.

### DETAILED DESCRIPTION

A holder for plants in an aqueous farm system may include air ejection holes for ejecting air into a region under canopies of the plants. The holder may include an internal passageway or volume for passing air from air intake ports to the air ejection holes. Fans may be mounted to the holder for forcing air into the air intake ports. The holder may be configured to increase ease of harvesting of the plants using robotic devices.

Large scale aqueous farm systems may include plants placed in structures such that roots of the plants may be exposed to an aqueous environment, while canopies of the plants are exposed to an atmospheric environment. For an aeroponic farm, the barriers or separators may enclose a mist environment. For example, an aeroponic farm system may include grow walls. For an aeroponic farm, the grow walls typically are part of an enclosure for a fog or mist environment. A grow wall may have openings in which plants are placed, with root systems of the plants extending into the fog or mist environment and a canopy of the plant extending out into an atmospheric environment. The grow wall therefore serves as a barrier or separation between an aqueous environment and an atmospheric environment. In some embodiments barriers or separations other than grow walls may be used.

The plants themselves may be held in receptacles. The receptacle may be for example a tube or pipe-like structure open on both ends, with the plant canopy extending out one end and the plant root extending out the other. The plants may be placed in the openings of the grow wall (or other barrier) by placing the receptacles in the openings of the grow wall.

In various embodiments, one or more holders in accordance with aspects of the invention may be overlaid on sides of the grow wall or other barrier or separator, with the holder also holding the receptacles and providing under-canopy air circulation. A holder in accordance with some embodiments of the invention may be an assembly that may be used to handle the plants and/or plant receptacles. Particularly, the holder may include a portion positioned between a barrier, for example a grow wall, and part of a plurality of plants or plant receptacles. The holder may be used, in some embodiments, to remove a group of one or more plants and/or receptacles from the grow wall.

In accordance with some embodiments the holder may have multiple air ejection holes in a surface of the holder facing the plant canopies. The air ejection holes may provide a passage to an interior airway or interior volume of the holder, into which air may be injected. In some embodiments one or more fans are coupled to the holder, for example at air injection ports into an interior airway or interior volume, so as to inject air into the holder. The air injected into the holder may then escape through the air ejection holes in the surface of the holder facing the canopies, providing for air circulation in the under-canopy region.

In some embodiments the holder includes an interior volume within a base. The interior volume within the base is separated from the mist environment, enclosed by the grow wall or other separator, by the grow wall and/or components of the base. The holder may be considered a housing in some embodiments. The holder has first apertures extending through the base for receiving plants and/or plant receptacles and second apertures extending into the interior volume of the base. Some such embodiments include a third aperture extending into the interior volume for providing air flow into the interior volume. Some such embodiments include a first fan positioned to provide the air flow through the third aperture into the interior volume. Some such embodiments may include a fourth aperture extending into the interior volume for providing air flow into the interior volume, and a second fan positioned to provide the air flow through the fourth aperture into the interior volume. In some such embodiments, the first apertures have a diameter at least ten times greater than the second apertures. In some embodiments the second apertures are uniformly arranged around the first apertures.

In some embodiments the holder may be considered a bracket. The bracket may include a first pair of arms extending from the base, for example to allow for removal of the bracket from the grow wall (or other barrier) by robotic means. In some embodiments the bracket may include additional pairs of arms, for example to support the bracket on a floor or the like.

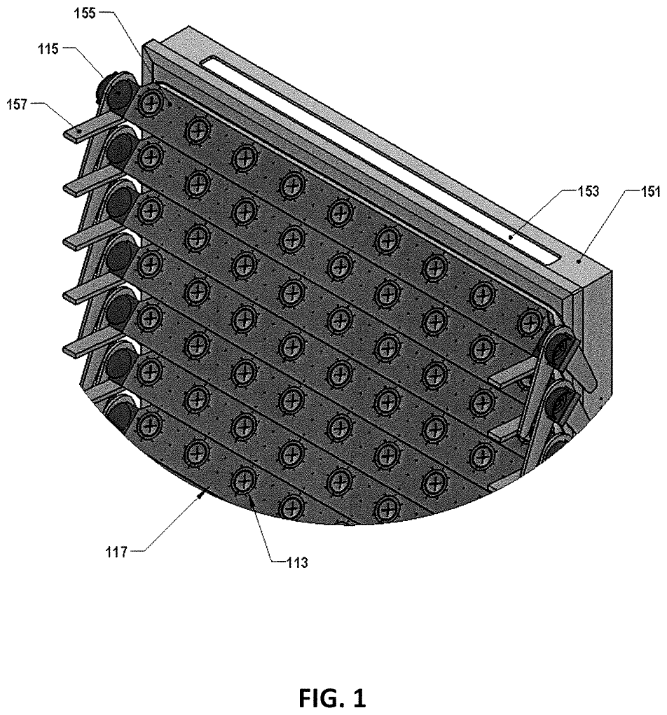

FIG. 1 illustrates a portion of a panel 151 of a grow wall with holders, in the form of what may be termed brackets, in accordance with aspects of the invention. The panel may be part of a structure that encloses an aqueous environment, for example a mist of an aeroponic environment. The grow wall may have plants in openings of the wall, with the brackets holding the plants. Roots of the plants would be exposed in the aqueous environment out one end of the opening, with a canopy of the plant exposed to an external atmospheric environment out the other end of the opening.

In FIG. 1, the panel 151 includes an opening 153 at a top of panel, for example for accessing the enclosed mist environment. The panel 151 also has openings (not visible in FIG. 1) defined through a vertical wall of the panel 151. The openings may be used to pass a portion of a plant or a plant receptacle holding a plant through the vertical wall.

A holder, or a plurality of holders 155 as shown in FIG. 1, is overlaid on the vertical wall. The holders include openings, for example opening 113, over the openings of the vertical wall, such that plants or plant receptacles inserted into the openings of the holders are also inserted into the openings of the vertical wall. In accordance with the shown embodiment, the openings are configured in an array of rows and columns, with each holder 155 holding a row of plants. However, various other embodiments may have the openings configured in other arrangements. For example, in some embodiments each bracket holds a portion of a row of plants, in some embodiments each bracket holds plants in a same column, and in some embodiments each bracket holds a certain number of plants in particular rows and columns forming a particular polygonal shape such as, but not limited to, a square or a rectangle. Each bracket also includes one or more couplings 157 that allow an automated movement device to couple to an assembly bracket assembly to insert and/or remove the plants from the openings in the wall.

The bracket also provides an under-canopy air circulation system to induce an airflow under the plant canopies over a surface of the bracket. Each bracket includes a plurality of air ejection holes 117 between the openings 113 for the plants. The air ejection holes extend through a surface of the bracket base facing the plant canopies and into an interior volume of the base. The base, with its interior volume, may be considered a housing. A fan 115 is located at an edge of the base of each bracket. The fan forces air through an air injection port on the side of each bracket, with each air injection port extending through a side wall of the bracket and into the interior volume of the base. In some embodiments the fan forces air from a side of the bracket into the interior volume, in some embodiments an air conduit may be provided such that air from other sources is presented to the fan.

In accordance with some embodiments a bracket assembly is provided for use in the automated handling of plants. In some of these embodiments, the plant is placed in a plant receptacle that holds the plant in place within the bracket. The bracket holds a group of one or more plant and/or plant receptacles and allows an automated system to couple to the bracket in a manner that does not interfere with the exposed plant canopies and/or root systems of the plants being handled. This allows an automated system to handle the plants to safely insert and/or remove the plants from the growing wall as well as transport the plants and/or plants held by the plant receptacles, outside the grow wall.

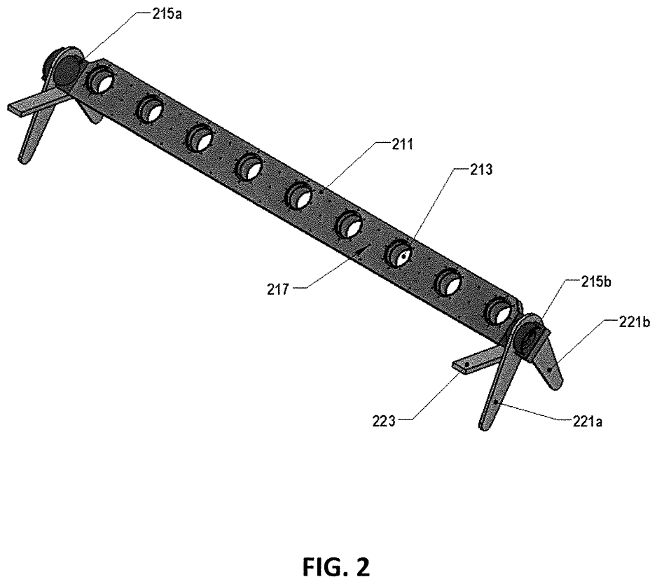

FIG. 2 is a top perspective view of a bracket in accordance with some embodiments of the invention. The bracket has a base 211. The base extends along a longitudinal axis from a first end to a second end, with a top surface of the base visible in FIG. 2. Openings 213 are defined through the base 211, from the top surface to a bottom surface (not visible in FIG. 2), with the openings substantially perpendicular to the longitudinal axis. Plants, for example in plant receptacles, may be placed in the openings, generally with one plant per opening. When the base is installed on a grow wall or other barrier or separator, the top surface of the base faces canopies of the plants. In the shown embodiments, openings 213 are substantially circular. However, openings 213 may be various other shapes in accordance with various other embodiments of the invention. In the shown embodiment, the base is rectangular. However, the base may be various other shapes in accordance with various other embodiments of the invention.

The base includes air ejection holes 217. The air ejection holes are arranged between the openings 213 for receiving plants. The air ejection holes do not extend entirely through the base, instead only extending into an interior volume of the base. The interior volume provides an air passageway between air injection ports (not visible in FIG. 2) of the base and the air ejection holes. The air injection ports are located along side edges of the base, as are fans 215a,b for forcing air into the air injection ports.

In the embodiment of FIG. 2, the base has sufficient length and width to have plant openings for corresponding openings in a single row of openings in a grow wall and/or panel of a grow wall. In accordance with some other embodiments, the base may have sufficient length for a lesser number of openings in a row, and/or a sufficient width for openings corresponding to two or more columns of openings of a grow wall.

The bracket of FIG. 2 also has a pair of arms 223 that extend out of opposing ends of the base. The arms may be used by an automated system to withdraw the bracket from the grow wall, along with any plants held by the bracket. The arms extend outwards from the base at a substantially perpendicular angle to the longitudinal axis of the base. Each arm may be gripped by a robotic arm, clamp, or other gripping device so that the automated system may move the bracket and in turn the plants and/or plant receptacles using an automated system. In accordance with some other embodiments, slots may be defined in the opposing ends to allow a fork, rod, or some other device with an extended shaft to be inserted into the slot to move the bracket.

In some embodiments, and also as shown in FIG. 2, the bracket may include pairs of legs 221a and 221b for standing the bracket on a surface. The legs extend in different directions from a common location, creating a co-planar y-like formation. The legs may have a sufficient length to allow the bracket to be placed on a surface with plants and/or plant receptacles installed in the bracket. The legs 221a and 221b are shown as affixed to opposing ends of the bracket, however, the legs may be attached to other portions of the base in various embodiments.

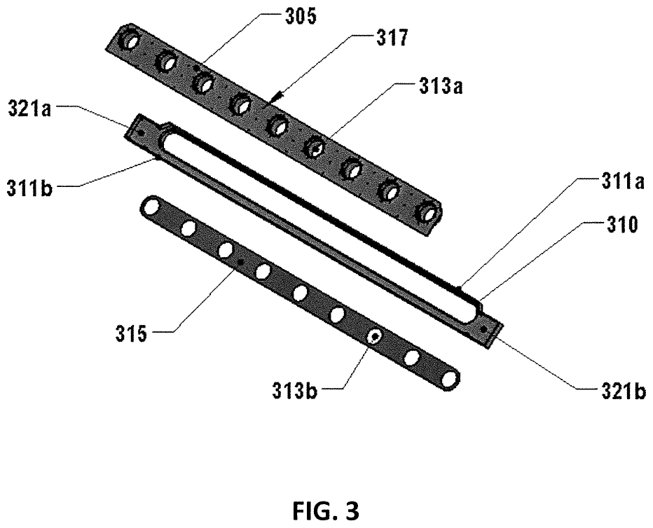

The base of the bracket of FIG. 2 may be unitarily formed, but in some embodiments is comprised of separate components. An exploded view of example components for the base of the bracket of FIG. 2 is shown in FIG. 3.

In FIG. 3, a top component 305 has a generally planar longitudinally extending surface, with openings 313a defined through the surface. For each opening, cylindrical sidewalls extending downward from a lower side of the surface. The top surface also has a plurality of air ejection holes 317 extending through the surface.

A bottom component 315 is a generally planar longitudinally extending surface with openings 313b that correspond to the openings in the top component. The openings 313b are dimensioned to be the same size as the openings 313a in the top component in some embodiments, or are sized to receive ends of the cylindrical sidewalls of the top component, for example in an interference fit, in other embodiments.

A spacer 310 couples the top component and bottom component. The spacer has opposing longitudinal walls 311a,b spaced apart so as to fit against or under longitudinal edges of the top component and bottom component. The longitudinal walls, along with the top component and the bottom component, define an interior volume of the bracket. In FIG. 3, surfaces 321a, 321b extend outward from and perpendicular to the opposing ends of the longitudinal walls to allow for placement of the other components, for example fans. In some embodiments gaps between ends of the longitudinal walls provide air injection ports into the interior volume of the bracket. Air injected into the air injection ports may escape via the air ejection holes 317 in the top component.

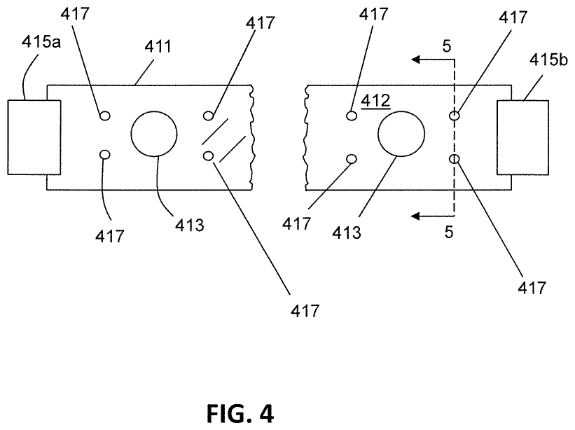

FIG. 4 is a partial top view of portions, including end portions, of a further bracket that provides under-canopy air circulation in accordance with aspects of the invention. The further bracket also include a plurality of air ejection holes 417. The air ejection holes extend through an upper surface and to an interior volume of the elongated housing. The further bracket includes an elongated housing 411. The housing may be considered a base. The elongated housing includes a plurality of openings 413 through the housing, with the openings arranged linearly along a center longitudinal axis defined by the elongated housing. The openings are dimensioned to receive a plant, which may be held in a plant receptacle, with a canopy of plant extending out of a top side 412 of the housing and roots of the plant extending out of a bottom side of the housing (with “top” and “bottom” sides labeled in terms of FIG. 4 being considered a “top” view, and not in terms of positioning of the bracket during operations). The air ejection holes are arranged such that a group of air ejection holes surround each opening 413 holding a plant. In operation, with air expelled from the air ejection holes, this arrangement facilitates airflow under the canopy of plants installed in the openings 413. In the shown embodiment, the air ejection holes 417 are arranged in a square pattern around an opening 413. However, other patterns that may induce an airflow under plant canopies installed in the openings 413 may be used in other embodiments. In some embodiments the air ejection holes are ten times smaller, or more than ten times smaller, than the openings 413.

The housing also has an opening (not shown in FIG. 4) defined through one or both sides at one or both ends of the housing, to induce air flow into the internal volume. A fan 415a, 415b may be inserted into or at the opening, and operated to induce airflow into the internal volume, with the airflow escaping, at least in part, via the air ejection holes. In some embodiments, both fan 415a and fan 415b are configured to blow air into the internal volume. In some other embodiments, fan 415a is configured to blow air into the internal volume and fan 415b is configured to blow air out of the internal volume to better induce an airflow through the internal volume. In some embodiments, fan 415a and/or fan 415b may be battery powered. In some other embodiments, fan 415a and/or fan 415b may utilize an external power supply.

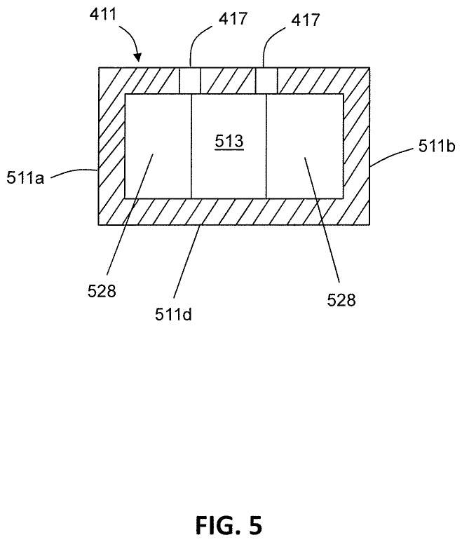

FIG. 5 is a cross sectional view of the bracket that provides under-canopy air circulation of FIG. 4. The base includes a top surface 411, a bottom surface 511d, and sidewalls 511a,b interconnecting longitudinal edges of the top surface and bottom surface. The top surface, bottom surface, and sidewalls define an internal volume 528 within the base. The internal volume 528 provides a passage through the base 411 through which air may flow. The air ejection holes 417 extend through the top surface to the internal volume. The air ejection holes allow air to flow out of the internal volume 528, and under that canopies of plants installed in the openings 513 that extend through the base.

Although the invention has been discussed with respect to various embodiments, it should be recognized that the invention comprises the novel and non-obvious claims supported by this disclosure.

1. A bracket for use in holding plants in an aqueous farm system, comprising:
a base that has a plurality of first openings, each of the plurality of openings dimensioned to receive a plant or plant receptacle, the base having an internal volume wherein the base has a plurality of second openings through a first surface of the base into the internal volume, and wherein the base has a third opening into the internal volume; and
a fan near the third opening to inject air into the internal volume.

2. The bracket of claim 1 wherein the third opening is defined through a side on a first end of the base.

3. The bracket of claim 2 wherein the fan is affixed in the third opening.

4. The bracket of claim 2, wherein the base has a fourth opening defined through a side on a first end of the base and a further fan is affixed in the fourth opening.

5. The bracket of claim 4, wherein the plurality of second openings are smaller than the plurality of first openings and are proximate the plurality of first openings on the surface.

6. The bracket of claim 1, wherein each of the plurality of first openings is configured to receive a plant receptacle holding a plant.

7. The bracket of claim 1 wherein a set of openings from the plurality of second openings are located around one of the plurality of first openings.

8. The bracket of claim 1 wherein each of the plurality of first openings is at least ten times larger the each of the plurality of second openings.

9. The bracket of claim 1 wherein each of the plurality of first openings comprises a sidewall that separates an opening from the internal volume in the base.

10. The bracket of claim 1, further comprising a first pair of legs and a second pair of legs extending from the base.

11. A bracket for an aqueous farm system, comprising:
a base that extends along a longitudinal axis from a first end to a second end and having a top surface and a bottom surface with a plurality of first openings defined through the base from the top surface to the bottom surface substantially perpendicular to the longitudinal axis wherein each of the plurality of openings is configured to receive one of a plurality of plant receptacles, an internal volume defined within the base, and a plurality of second openings proximate the plurality of first openings that extend through the top surface into the internal volume;
a first arm extending outwards from the top surface of the base proximate the first end of the base at a substantially perpendicular angle to the longitudinal axis of the base; and
a second arm extending outwards from the top surface of the base proximate the second end of the base at a substantially perpendicular angle to the longitudinal axis of the base.

12. The bracket of claim 11 wherein the base has a third opening defined through a side on a first end of the base.

13. The bracket of claim 11 further comprising a fan positioned to force air into the third opening.

14. The bracket of claim 13 wherein the base has a fourth opening defined through a side on a second end of the base.

15. The bracket of claim 14 further comprising a further fan positioned to force air into the fourth opening.

16. The bracket of claim 11, wherein each of the plurality of first openings is configured to receive a plant receptacle holding a plant.

17. The bracket of claim 11 wherein a set of openings of the plurality of second opening are located around one of the plurality of first openings.

18. The bracket of claim 11 wherein each of the plurality of first openings is ten times larger the each of the plurality of second openings.

19. The bracket of claim 11 wherein each of the plurality of first openings comprises a sidewall that separates an opening from the internal volume in the base.

20. The bracket of claim 11, further comprising a first pair of legs and a second pair of legs extending from the base.
